(19) United States
(12) Patent Application Publication
(10) Pub. No.: US 2002/0078838 A1
(43) Pub. Date: Jun. 27, 2002

(54) Lithographic printing plate conditioner and method for lithographic printing

(76) Inventors: Michael V. Oberski, Ypsilanti, MI (US); Kevin P. Kingman, Brownstown, MI (US)

Correspondence Address: HARNESS, DICKEY & PIERCE, P.L.C., P.O. BOX 828, BLOOMFIELD HILLS, MI, 48303, US

(21) Appl. No.: 10/037,122

(22) Filed: Nov. 9, 2001

Related U.S. Application Data
(63) Continuation-in-part of application No. 09/856,408, filed on May 17, 2001.
Application No. 09/856,408 is a 371 of international application No. PCT/US99/28173, filed on Nov. 29, 1999.
Application No. PCT/US99/28173 is a continuation of application No. 09/201,411, filed on Nov. 30, 1998, now Pat. No. 6,140,392.

(51) Int. Cl. B41L 7/00

(52) U.S. Cl. 101/130

(57) ABSTRACT

A printing method includes printing an ink with a lithographic printing press having a printing plate, stopping the printing press, and applying a plate conditioner to the printing plate. The plate conditioner contains a liquid having hydroxyl functionality and a solid organic compound that is at least partially soluble in the liquid having hydroxyl functionality. The method is especially advantageous when the ink is a single fluid lithographic ink containing an emulsified or dispersed fluid phase.

### CROSS-REFERENCE TO RELATED APPLICATIONS

This application is a continuation-in-part of U.S. patent application Ser. No. 09/856,408 filed on May 17, 2001 which is a national stage application of international application PCT/US99/28173, filed Nov. 29, 1999, which is a continuation of U.S. patent application Ser. No. 09/201,411 filed on Nov. 30, 1998, now U.S. Pat. No. 6,140,392, issued Oct. 31, 2000, the disclosure of which is incorporated herein by reference.

### FIELD OF THE INVENTION

The present invention relates to lithographic printing methods and conditioners for lithographic printing plates.

### BACKGROUND OF THE INVENTION

In lithographic printing, an inked printing plate contacts and transfers an inked image to a rubber blanket, and then the blanket contacts and transfers the image to the surface being printed. Lithographic plates are produced by treating the image areas of the plate with an oleophilic material and ensuring that the non-image areas are hydrophilic. In a typical lithographic printing process, the plate cylinder first comes in contact with dampening rollers that transfer an aqueous fountain solution to the hydrophilic non-image areas of the plate. The dampened plate then contacts an inking roller, accepting the ink only in the oleophilic image areas.

The ink must adhere to the printing areas, but only the printing areas, of the plate in order to produce a sharp, well-defined print. If the ink builds up in non-print areas on the plate or blanket, the result is toning (ink printed in non-image areas). The press must then be shut down and the plate and blanket must be cleaned.

Kingman et al., U.S. Pat. No. 6,140,392, issued Oct. 31, 2000 describes a single-fluid lithographic ink in which a polyol phase is dispersed or emulsified in a hydrophobic ink phase. The ink phase contains a carboxylic acid-functional vinyl polymer. The polyol phase includes at least a liquid polyol. The stability is such that the two phases do not separate in the fountain. During application of the ink, however, the emulsion breaks and the polyol comes to the surface, wetting out the areas of the plate that are not to receive ink. Inks that are stable in the fountain but break quickly to separate on the plate print cleanly without toning and provide consistent transfer characteristics.

When the press is stopped, for example between print runs or overnight, the non-image areas can become “sensitized” so that they accept the ink, rather than the fountain solution. In traditional two-fluid lithography (separate sources of fountain solution and printing ink), the plate is cleaned with an aqueous surfactant solution containing a mild abrasive to scrub the dried ink and other debris from the grain of the plate when the press is stopped. After cleaning, a plate conditioner, usually an aqueous gum solution such gum arabic solution, is applied to the plate to prevent the plate from becoming sensitized. The plate conditioner protects the plate

It has been found that the traditional plate cleaner and conditioner method is ineffective for cleaning and protecting the plate when printing with a single-fluid lithographic ink.

### SUMMARY OF THE INVENTION

In a single-fluid lithographic printing method, a plate conditioner containing an organic liquid having hydroxyl functionality and a solid organic compound at least partially soluble in the organic liquid having hydroxyl functionality is applied to the printing plate when printing is temporarily stopped. The organic liquid having hydroxyl functionality preferably has a low evaporation rate. By “low evaporation rate” we mean an evaporation rate of at least 1000, preferably at least 2000, based on diethyl ether being 1. The conditioner has at least about 5% by weight of the organic liquid having hydroxyl functionality. The organic liquid having hydroxyl functionality solution forms a continuous film or layer on the plate to protect the plate when the press is not being run, for example between printing jobs or if the press is shut down overnight.

### DETAILED DESCRIPTION OF THE PREFERRED EMBODIMENTS

The plate conditioner of the invention contains an organic liquid having hydroxyl functionality and a solid organic compound that is at least partially soluble in the organic liquid having hydroxyl functionality. The solid organic compound is a solid at room temperature and may be, for example, a solid polyol or a gum. By “a solid at room temperature” it is meant the solid organic compound has a melting point of at least about 20° C. (the melting point of glycerol). Preferably, the solid organic compound has a melting point of about 25° C. or higher. By “solution” we mean the organic liquid having hydroxyl functionality in which at least some of the solid organic compound is dissolved. By “at least partially soluble in the liquid having hydroxyl functionality” we mean that the solid organic compound will form at least a 1% by weight solution in the liquid having hydroxyl functionality.

In the method of the invention, the organic liquid having hydroxyl functionality wets out the plate areas to be protected. The organic liquid having hydroxyl functionality, however, may evaporate before the press is started again. If so, the solid organic compound remains on the plate to protect the hydrophilic plate areas from oxidation or degradation from solvents or other chemicals in the press room that would be aggressive toward the plate material. Even in the case of a solid organic compound that has a melting point at 20° C. or slightly higher, for example glycerol, the evaporation rate is slow enough that the solid organic compund provides the desired protection to the plate.

An “organic liquid having hydroxyl functionality” is liquid at less than 20° C. at standard pressure and has at least one hydroxyl group. Preferred organic liquids having hydroxyl functionality include, without limitation, liquid polyols such as 1,2-propanediol, 1,3-propanediol, diethylene glycol, triethylene glycol, tetraethylene glycol, 1,4-butanediol, 1,3-butanediol, glycerol and monoesters of glycerol such as glycerine monoacetate, and liquid glycol derivatives such as ethylene glycol monobutyl ether, propylene glycol monomethyl ether, diethylene glycol monomethyl ether, and combinations of these, and the like.

Suitable examples of the solid organic compound include, without limitation, gum arabic and other gums or starches that are soluble in the polyol; cellulosics such as carboxyl methyl cellulose, carboxyl ethyl cellulose, sodium, potassium, or other salts of the carboxyl celluloses; poly(vinyl alcohol); poly(vinyl acetate); poly(vinyl pyrrolidone), solid polyalkylene glycols, including polyethylene glycols, polypropylene glycols, and block copolymers; neopentyl glycol, trimethylolpropane, glycerol, pentaerythritol, dipentaerythritol, 2,2,4-trimethylpentanediol, hyperbranched polyols based on polyols having three or more hydroxyl groups, trimethylolpropane, triethylolpropane, and pentaerythritol, and combinations of these. Suitable examples of hyperbranched polyols are described in U.S. Pat. No. 5,663,247 (Sorensen et al.) and U.S. Pat. No. 5,418,301 (Hult et al.), the disclosures of each of these patents being incorporated herein by reference.

The plate conditioner preferably includes at least about 5% by weight, more preferably at least about 10% by weight, even more preferably at least about 25% by weight, and still more preferably at least about 50% by weight of the organic liquid having hydroxyl functionality. The plate conditioner preferably includes up to about 99% by weight, more preferably up to about 98% by weight, even more preferably up to about 95% by weight, and still more preferably up to about 90% by weight of the organic liquid having hydroxyl functionality. The plate conditioner preferably includes from about 25% to about 98% by weight, more preferably from about 50% to about 95% by weight, and still more preferably from about 70% to about 90% by weight of the organic liquid having hydroxyl functionality.

The plate conditioner also preferably includes at least about 0.05% by weight, more preferably at least about 0.1% by weight of the solid organic compound, and preferably up to about 5% by weight, more preferably up to about 1% by weight of the solid organic compound. Preferably, all of the solid is dissolved in the organic liquid having hydroxyl functionality.

The plate conditioner may further include water. The water may be up to about 94.95% by weight, more preferably up to about 94.9% by weight, and still more preferably up to about 89.9% by weight of the plate conditioner Preferably at least about 1% by weight, more preferably at least about 5% by weight of water is used in the plate conditioner. If the plate conditioner has water, the water is preferably from about 5% to about 30% by weight of the plate conditioner.

If the solid organic compound has ionizable groups, then an aqueous plate conditioner may also include a salting compound. When the gum or polyol has amino groups, an acid, including weak acids like lactic acid, citric acid, acetic acid, or combinations of these, may be used to salt the amino group. When the gum or polyol has acidic groups, they may be neutralized with a base such as ammonia or an amine.

The plate conditioner has particular utility with a single fluid lithographic ink having an emulsified hydrophilic fluid phase. It has been found that traditional plate conditions that do not contain the liquid having hydroxyl functionality are ineffective with this technology. First, the gums of traditional plate conditioners do not remove the single fluid ink from the plate. Secondly, when the press is stopped for only a short time, the conditioner would not be dry and would interfere with the printing. In using the plate conditioner of the invention, however, the liquid having hydroxyl functionality wets out the plate entirely and is believed to behave as a surfactant in wetting out the surface of the printing plate.

In a preferred embodiment, the plate conditioner is used to clean plates in a lithographic printing process using a single fluid lithographic printing ink composition that includes a continuous hydrophobic phase including a polymeric material and an emulsified hydrophilic fluid phase. The lithographic printing press is stopped and the ink is wiped from the plate. The plate conditioner of the invention is then applied to the surface of the plate. After a desired time, the printing press is started and printing with the single fluid lithographic printing ink is resumed.

The hydrophilic fluid phase contains water and/or a liquid polyol. Polyethylene glycol oligomers such as diethylene glycol, triethylene glycol, and tetraethylene glycol, as well as ethylene glycol, propylene glycol, and dipropylene glycol, are examples of liquid polyols that are preferred for the hydrophilic fluid phase of the single-fluid lithographic ink.

In a preferred embodiment, the emulsified fluid phase of the single fluid ink also contains a solid polyol. The solid polyol may be any of those already mentioned for the plate conditioner. Including the solid polyol in the polyol phase aids in keeping the printing plate clean during printing. The ink tends not to get in the pores of the printing plate, and the ink can be easily wiped from printing plate when the press is stopped.

The hydrophobic phase of the preferred lithographic printing ink composition comprises at least a vinyl polymer having functional groups that form hydrogen bond interactions with the water and/or liquid polyols of the emulsified fluid phase. The term “vinyl polymer” when used in conjunction with the present invention includes polymers prepared by chain reaction polymerization, or addition polymerization, through carbon-carbon double bonds, using vinyl monomers such as acrylic and methacrylic monomers, vinyl aromatic monomers including styrene, and monomers copolymerizable with these. The vinyl polymers of the invention preferably are branched by including in the polymerization reaction monomers that have two reaction sites. When the vinyl polymer is branched, it nonetheless remains usefully soluble. By “soluble” it is meant that the polymer can be diluted with one or more solvents. (By contrast, polymers may be crosslinked into insoluble, three-dimensional network structures that are only be swelled by solvents.) The branched vinyl polymers of the invention unexpectedly retain solubility in spite of significant branching.

Examples of hydrogen bonding groups are well known in the art and include, without limitation, esters, carboxyls, hydroxyls, amines, amides, anhydrides, sulfoxides, sulfones, and mercaptans. Hydrogen bonds are energetically favorable interactions between a hydrogen donating species and a hydrogen accepting species. Thus, a hydrogen bond is made of a donor-acceptor pair. The donor in a hydrogen bond is a chemical functional group that has a slightly acidic hydrogen atom bonded to an atom that has at least one lone pair of electrons. The atom with at least one lone pair of electrons is most commonly oxygen, nitrogen, or sulfur so that donor species include such functional groups as carboxyls, hydroxyls, amines, amides, and mercaptans. The acceptor species in a hydrogen bond pair is a chemical functional group that contains an atom having at least a lone pair of electrons, usually oxygen, nitrogen, or sulfur. Such atoms occur in all of the functional groups listed above. It will be appreciated that the same chemical functional group on a molecule may serve as both the donor species and the acceptor species of a hydrogen bond pair. For example, an alcohol or glycol having a hydroxyl group may hydrogen bond with itself because the slightly acidic hydrogen on the hydroxyl group can interact with the lone pairs on the oxygen atoms of the hydroxyl group. In other situations, the donor and acceptor species may be different, for example, an amide group may hydrogen bond with an alcohol in several ways. For example a hydrogen on the nitrogen of an amide group may form an energetically favorable interaction with a lone pair on the oxygen of an alcohol. At the same time, the slightly acidic hydrogen on the hydroxyl group of the alcohol may form a hydrogen bond to lone pairs on either the carboxyl oxygen or the amide nitrogen of the amide functional group.

Such hydrogen bond interactions are energetically favorable. A consequence is that hydrogen bonds tend to spontaneously form in systems that are suitable for their formation. As a result, the hydrogen bonding groups on the functionalized vinyl polymers of the invention can spontaneously form hydrogen bonds with components in the polyl phase, such as water, liquid polyols, and solid polyols. Some hydrogen bonding groups on the functionalized vinyl polymers may serve as acceptor species, others as donor species, and others as both. For example, an ester group would serve only as a hydrogen bond acceptor, while an amide functional group as discussed above may serve both as donor and acceptor. The components of the emulsified fluid phase can act both as acceptors and donors because they contain hydroxyl groups.

The strength of a hydrogen bond is related to the relative acidity and bacisity of the donor and acceptor species. A hydrogen bond can be thought of as a type of Lewis base/Lewis acid interaction in which the acidic hydrogen atom serves as the Lewis acid and the available electron pair on the acceptor serves as a Lewis base. In general, a hydrogen bond is stronger if it is between Lewis acid base pairs that are more strongly acidic and basic. If it is desired to strengthen the hydrogen bond formed between a donor with a weakly acidic hydrogen atom and an acceptor, it is possible to add acidic materials to the donor species to increase its hydrogen bonding affinity. Alternatively, a weakly basic material may be added to a hydrogen acceptor to increase the strength of a hydrogen bond. In some situations, an acceptor may be so basic and a donor may be so acidic that a hydrogen bond is not formed but rather an ionic interaction occurs. In such a situation, ionic interaction may be moderated and controlled by appropriate additions of weak acids and weak basis to the donor and acceptors as described above.

In a preferred embodiment, the functionalized vinyl polymers of the invention contain carboxyl groups as the hydrogen bonding group. Such polymers can be prepared by polymerizing a monomer mixture that includes at least one acid functional monomer or at least one monomer that has a group that is converted to an acid group following polymerization, such as an anhydride group. Examples of acid functional or anhydride functional monomers include, without limitation, α,β-ethylenically unsaturated monocarboxylic acids containing 3 to 5 carbon acids such as acrylic, methacrylic, and crotonic acids; α,β-ethylenically unsaturated dicarboxylic acids containing 4 to 6 carbon atoms and the anhydrides and monoesters of those acids, such as maleic anhydride, and fumaric anhydride; and acid functional derivatives of copolymerizable monomers, such as the hydroxylethyl acrylate half ester of succinic acid.

It is preferred to include an acid-functional monomer such as acrylic acid, methacrylic acid, or crotonic acid, or an anhydride monomer such as maleic anhydride or itaconic anhydride that may be hydrated after polymerization to generate acid groups. It is preferred for the acid functional vinyl polymer to have an acid number of at least about 3 mg KOH per gram nonvolatile, preferably from about 6 to about 30 mg KOH per gram non-volatile, and more preferably from about 8 to about 25 mg KOH per gram non-volatile, based on the non-volatile weight of the vinyl polymer.

In another preferred embodiment, the functionalized vinyl polymers of the invention contain amide hydrogen bonding groups. Such polymers are prepared by polymerization of a monomer mixture that includes at least one amide functional monomer. Examples of amide functional monomers include, without limitation, acrylamide, methacrylamide, N-alkylacrylamides, N-alkylmethacrylamides, N,N′-dialkylacrylamides, and N,N′ dialkylmethacrylamides. Specific examples include N-methylacrylamide, N-methylmethacrylamide, N-isopropyl acrylamide, N-isopropyl methacrylamide, N,N-dimethylacrylamide, N,N′-dimethylmethacrylamide, and N,N′-diisopropylmethacrylamide.

In another preferred embodiment, the functionalized vinyl polymers of the invention contain hydroxyl groups as the hydrogen bonding group. Such functional groups may be incorporated into the vinyl polymer by polymerizing a monomer mixture that includes at least one hydroxyl functional monomer. Examples of hydroxyl functional monomers include, without limitation, hydroxy alkyl esters of acrylic acid or methacrylic acid, such as hydroxyethyl acrylate, hydroxyethyl metharylate, hydroxypropyl acrylate, hydroxypropyl methacrylate, hydroxybutyl acrylate, hydroxybutyl methacrylate, and combinations of these. Hydroxyl functionality can also be obtained by polymerizing vinyl acetate, followed by hydrolysis of the acetate group to provide the alcohol group. Because the hydroxyl group is a relatively weak acceptor group relative to the amide functional group and the carboxyl group discussed above, and because the acid on the hydroxyl group has weaker Lewis acid character than that on the carboxyl group discussed above, it is preferred to add weakly basic materials to the emulsified fluid phase in order to strengthen the hydrogen bonding between the functionalized vinyl polymer and the components of the emulsified fluid phase.

Other functional groups may be incorporated into the functionalized vinyl polymers of the invention. For example, a primary or secondary amine group may be incorporated by polymerizing a monomer mixture that includes an amine functional monomer such as amino alkyl esters of acrylic acid or methacrylic acid, or amino alkyl acrylamides or methacrylamides. Sulfoxide and sulfone groups may be incorporated by polymerizing vinyl sulfoxides and sulfones. The functionalized vinyl polymers of the invention may also contain sulfide groups for example by converting a group on the vinyl polymer to sulfoxide, sulfonamide, phosphonamide, and so on.

In a preferred embodiment, the vinyl polymers of the single fluid ink are significantly branched but usefully soluble. The branched vinyl polymers may be diluted, rather than swollen, by addition of solvent. The branching may be accomplished by at least two methods. In a first method, a monomer with two or more polymerizable double bonds is included in the polymerization reaction. In a second method, a pair of ethylenically unsaturated monomers, each of which has in addition to the polymerizable double bond at least one additional functionality reactive with the additional functionality on the other monomer, are included in the monomer mixture being polymerized. Preferably, the reaction of the additional functional groups takes place during the polymerization reaction, although this is not seen as critical in the formation of a polymer according to the invention and the reaction of the additional functional groups may be carried out partially or wholly before or after polymerization. A variety of such pairs of mutually reactive groups are possible. Illustrative examples of such pairs of reactive groups include, without limitation, epoxide and carboxyl groups, amine and carboxyl groups, epoxide and amine groups, epoxide and anhydride groups, amine and anhydride groups, hydroxyl and carboxyl or anhydride groups, amine and acid chloride groups, alkylene-imine and carboxyl groups, organoalkoxysilane and carboxyl groups, isocyanate and hydroxyl groups, cyclic carbonate and amine groups, isocyanate and amine groups, and so on. When the hydrogen bonding group, such as carboxyl or anhydride group, is included as one of the reactive groups, it is used in a sufficient excess to provide the required hydrogen bonding functionality in the vinyl polymer. Specific examples of such monomers include, without limitation, glycidyl (meth)acrylate with (meth)acrylic acid, N-alkoxymethylated acrylamides (which react with themselves) such as N-isobutoxymethylated acrylamide, gamma-methacryloxytrialkoxysilane (which reacts with itself), and combinations thereof. In connection with the description of this invention, the term “(meth)acrylate” will be used to refer to both the acrylate and the methacrylate esters and the term “(meth)acrylic” will be used to refer to both the acrylic and the methacrylic compounds.

Preferably, the vinyl polymer of the single fluid ink is polymerized using at least one monomer having two or more polymerizable ethylenically unsaturated bonds, and particularly preferably from two to about four polymerizable ethylenically unsaturated bonds. Illustrative examples of monomers having two or more ethylenically unsaturated moieties include, without limitation, (meth)acrylate esters of polyols such as 1,4-butanediol di(meth)acrylate, 1.6-hexanediol di(meth)acrylate, neopentyl glycol di(meth)acrylate, trimethylolpropane tri(meth)acrylate, tetramethylolmethane tetra(meth)acrylate, pentaerythritol tetra(meth)acrylate, dipentaerythritol penta(meth)acrylate, dipentaerythritol hexa(meth)acrylate, alkylene glycol di(meth)acrylates and polyalkylene glycol di(meth)acrylates, such as ethylene glycol di(meth)acrylate, butylene glycol di(meth)acrylate, diethylene glycol di(meth)acrylate, triethylene glycol di(meth)acrylate, and polyethylene glycol di(meth)acrylate; divinylbenzene, allyl methacrylate, diallyl phthalate, diallyl terephthalate, and the like, singly or in combinations of two or more. Of these, divinylbenzene, butylene glycol dimethacrylate, butanediol dimethacrylate, trimethylolpropane triacrylate, and pentaerythritol tetra-acrylate are highly preferred, and divinylbenzene is still more highly preferred.

Preferably, the branched vinyl polymer is polymerized using at least about 0.008 equivalents per 100 grams of monomer polymerized of at least one monomer having at least two ethylenically unsaturated polymerizable bonds, or 0.004 equivalents per 100 grams of monomer polymerized of each of two monomers having mutually reactive groups in addition to an ethylenically unsaturated polymerizable bond. Preferably, the branched vinyl polymer is polymerized using from about 0.012 to about 0.08 equivalents, and more preferably from about 0.016 to about 0.064 equivalents per 100 grams of monomer polymerized of the polyfunctional monomer or monomers having at least two ethylenically unsaturated polymerizable bonds or of the pair of monomers having one polymerization bond and one additional mutually reactive group.

The polyfunctional monomer or monomers preferably have from two to four ethylenically unsaturated polymerizable bonds, and more preferably two ethylenically unsaturated polymerizable bonds. In one embodiment it is preferred for the branched vinyl polymer to be prepared by polymerizing a mixture of monomers that includes from about 0.5% to about 6%, more preferably from about 1.2% to about 6%, yet more preferably from about 1.2% to about 4%, and even more preferably from about 1.5% to about 3.25% divinylbenzene based on the total weight of the monomers polymerized. (Commercial grades of divinylbenzene include mono-functional and/or nonfunctional material. The amount of the commercial material needed to provide the indicated percentages must be calculated. For example, 5% by weight of a material that is 80% by weight divinylbenzene/20% mono-functional monomers would provide 4% by weight of the divinylbenzene fraction.)

The optimum amount of (1) divinylbenzene or other monomer having at least two polymerizable ethylenically unsaturated bond or (2) pair of monomers having polymerizable group and additional, mutually-reactive groups that are included in the polymerization mixture depends to some extent upon the particular reaction conditions, such as the rate of addition of monomers during polymerization, the solvency of the polymer being formed in the reaction medium chosen, the amount of monomers relative to the reaction medium, the half-life of the initiator chosen at the reaction temperature and the amount of initiator by weight of the monomers, and may be determined by straightforward testing.

Other monomers that may be polymerized along with the polyfunctional monomers and the hydrogen bonding group-functional monomers (or monomers with groups that can later be converted to the hydrogen bonding groups) include, without limitation, esters of α,β-ethylenically unsaturated monocarboxylic acids containing 3 to 5 carbon atoms such as esters of acrylic, methacrylic, and crotonic acids; α,β-ethylenically unsaturated dicarboxylic acids containing 4 to 6 carbon atoms and the anhydrides, monoesters, and diesters of those acids; vinyl esters, vinyl ethers, vinyl ketones, and aromatic or heterocyclic aliphatic vinyl compounds. Representative examples of suitable esters of acrylic, methacrylic, and crotonic acids include, without limitation, those esters from reaction with saturated aliphatic and cycloaliphatic alcohols containing 1 to 20 carbon atoms, such as methyl, ethyl, propyl, isopropyl, n-butyl, isobutyl, tert-butyl, 2-ethylhexyl, lauryl, stearyl, cyclohexyl, trimethylcyclohexyl, tetrahydrofurfuryl, stearyl, sulfoethyl, and isobornyl acrylates, methacrylates, and crotonates; and polyalkylene glycol acrylates and methacrylates. Representative examples of other ethylenically unsaturated polymerizable monomers include, without limitation, such compounds as diesters of fumaric, maleic, and itaconic acids and anhydrides with alcohols such as methanol, ethanol, propanol, isopropanol, butanol, isobutanol, and tert-butanol. Representative examples of polymerizable vinyl monomers include, without limitation, such compounds as vinyl acetate, vinyl propionate, vinyl ethers such as vinyl ethyl ether, vinyl and vinylidene halides, and vinyl ethyl ketone. Representative examples of aromatic or heterocyclic aliphatic vinyl compounds include, without limitation, such compounds as styrene, α-methyl styrene, vinyl toluene, tert-butyl styrene, and 2-vinyl pyrrolidone. The selection of monomers is made on the basis of various factors commonly considered in making ink varnishes, including the desired glass transition temperature and the desired dilutability of the resulting polymer in the solvent or solvent system of the ink composition.

The preferred vinyl polymers may be prepared by using conventional techniques, preferably free radical polymerization in a semi-batch process. For instance, the monomers, initiator(s), and any chain transfer agent may be fed at a controlled rate into a suitable heated reactor charged with solvent in a semi-batch process. Typical free radical sources are organic peroxides, including dialkyl peroxides, such as di-tert-butyl peroxide and dicumyl peroxide, peroxyesters, such as tert-butyl peroxy 2-ethylhexanoate and tert-butyl peroxy pivalate; peroxy carbonates and peroxydicarbonates, such as tert-butyl peroxy isopropyl carbonate, di-2-ethylhexyl peroxydicarbonate and dicyclohexyl peroxydicarbonate; diacyl peroxides, such as dibenzoyl peroxide and dilauroyl peroxide; hydroperoxides, such as cumene hydroperoxide and tert-butyl hydroperoxide; ketone peroxides, such as cyclohexanone peroxide and methylisobutyl ketone peroxide; and peroxyketals, such as 1,1-bis(tert-butyl peroxy)-3,5,5-trimethylcyclohexane and 1,1-bis(tert-butyl peroxy) cyclohexane; as well as azo compounds such as 2,2′-azobis(2-methylbutanenitrile), 2,2′-azobis(2-methyl)propionitrile, and 1,1′-azobis(cyclohexanecarbonitrile). Organic peroxides are preferred. Particularly preferred is tert-butyl peroxy isopropyl carbonate. Chain transfer agents may also be used in the polymerization. Typical chain transfer agents are mercaptans such as octyl mercaptan, n- or tert-dodecyl mercaptan, thiosalicylic acid, mercaptocarboxylic acids such as mercaptoacetic acid and mercaptopropionic acid and their esters, and mercaptoethanol, which may provide hydrogen-bonding mercapto groups; halogenated compounds; and dimeric alpha-methyl styrene. Preferably, no chain transfer agent is included because of odor and other known drawbacks. The particular initiator and amount of initiator used depends upon factors known to the person skilled in the art, such as the reaction temperature, the amount and type of solvent (in the case of a solution polymerization), the half-life of the initiator, and so on.

The addition polymerization is usually carried out in solution at temperatures from about 20° C. to about 300° C., preferably from about 150° C. to about 200° C., more preferably from about 160° C. to about 165° C. Preferably, the polymerization is carried out with approximately the same reaction temperature and using the same initiator(s) throughout. The initiator should be chosen so its half-life at the reaction temperature is preferably no more than about thirty minutes, particularly preferably no more than about five minutes, and yet more preferably no more than about two minutes. Particularly preferred are initiators having a half-life of less than about one minute at a temperature of from about 150° C. to about 200° C. In general, more of the branching monomer can be included when the initiator half-life is shorter and/or when more initiator is used. The vinyl polymer vehicles of the invention preferably have little or no residual (unreacted) monomer content. In particular, the vinyl vehicles are preferably substantially free of residual monomer, i.e., have less than about 0.5% residual monomer, and even more preferably less than about 0.1% residual monomer by weight, based on the total weight of the monomers being polymerized.

In a semi-batch process, the monomer and initiator is added to the polymerization reactor over a period of time, preferably at a constant rate. Typically, the add times are from about 1 to about 10 hours, and add times of from about three to about five hours are common. Longer add times typically produce lower number average molecular weights. Lower number average molecular weights may also be produced by increasing the ratio of solvent to monomer or by using a stronger solvent for the resulting polymer.

In general, the branched vinyl polymer of the single fluid ink has a low number average molecular weight and a broad polydispersity. The number average molecular weight and weight average molecular weight of a vinyl polymer according to the invention can be determined by gel permeation chromatography using polystyrene standards, which are available for up to 6 million weight average molecular weight, according to well-accepted methods. Polydispersity is defined as the ratio of M_{w}/Mₙ. In a preferred embodiment, the vinyl polymer has a number average molecular weight (Mₙ) of at least about 1000, and more preferably at least about 2000. The number average molecular weight is also preferably less than about 15,000, more preferably less than about 10,000, and even more preferably less than about 8500. A preferred range for Mₙ is from about 1000 to about 10,000, a more preferred range for Mₙ is from about 2000 to about 8500, and an even more preferred range is from about 4000 to about 8000. The weight average molecular weight should be at least about 30,000, preferably at least about 100,000. The weight average molecular weight (M_{w}) is preferably up to about 60 million, based upon a GPC determination using an available standard having 6 million weight average molecular weight. A preferred range for M_{w} is from about 30,000 to about 55 million, a more preferred range for Mw is from about 100,000 to about 1 million, and a still more preferred range is from about 100,000 to about 300,000. Polymers having ultra-high molecular weight shoulders (above about 45 million), which can be seen by GPC, are preferably avoided for the M_{w} range of from about 100,000 to about 300,000. The polydispersity, or ratio of M_{w}/Mₙ, may be up to about 10,000, preferably up to about 1000. The polydispersity is preferably at least about 15, particularly preferably at least about 50. The polydispersity preferably falls in the range of from about 15 to about 1000, and more preferably it falls in a range of from about 50 to about 800.

The theoretical glass transition temperature can be adjusted according to methods well-known in the art through selection and apportionment of the commoners. In a preferred embodiment, the theoretical T_{g} is above room temperature, and preferably the theoretical T_{g} is at least about 60° C., more preferably at least about 70° C. The methods and compositions of the present invention preferably employ vinyl polymers having a T_{g} of from about 50° C. to about 125° C., more preferably from about 60° C. to about 100° C., and even more preferably from about 70° C. to about 90° C.

The hydrogen bonding vinyl polymer, which may be a branched vinyl polymer, is preferably combined with other polymers in the ink composition. Examples of suitable other polymers that may be combined with the hydrogen-bonding vinyl polymer include, without limitation, polyesters and alkyds, phenolics, rosins, cellulosics, and derivatives of these such as rosin-modified phenolics, phenolic-modified rosins, hydrocarbon-modified rosins, maleic modified rosin, fumaric modified rosins; hydrocarbon polymers, other acrylic or vinyl polymers, polyamides, and so on. Such polymers may be included in amounts of up to about 6 parts by weight to about 1 part by weight of the hdyrogen bonding vinyl polymer of the invention, based upon the nonvolatile weights of the polymers.

In addition to the hydrogen bonding vinyl polymer and any optional second polymer, the ink compositions preferably include one or more solvents. In a preferred embodiment of the invention, the hydrogen bonding vinyl polymer forms a solution or apparent solution having no apparent turbidity in the solvent or solvents of the ink formulation. The particular solvents and amount of solvent included is determined by the ink viscosity, body, and tack desired. In general, non-oxygenated solvents or solvents with low Kauri-butanol (KB) values are used for inks that will be in contact with rubber parts such as rubber rollers during the lithographic process, to avoid affecting the rubber. Suitable solvents for inks that will contact rubber parts include, without limitation, aliphatic hydrocarbons such as petroleum distillate fractions and normal and iso paraffinic solvents with limited aromatic character. For example, petroleum middle distillate fractions such as those available under the tradename Magie Sol, available from Magie Bros. Oil Company, a subsidiary of Pennsylvania Refining Company, Franklin Park, Ill., under the tradename ExxPrint, available from Exxon Chemical Co., Houston, Tex., and from Golden Bear Oil Specialties, Oildale, Calif., Total Petroleum Inc., Denver, Colo., and Calumet Lubricants Co., Indianapolis, Ind. may be used. In addition or alternatively, soybean oil or other vegetable oils may be included.

When non-oxygenated solvents such as these are used, it is generally necessary to include a sufficient amount of at least one monomer having a substantial affinity for aliphatic solvents in order to obtain the desired solvency of the preferred branched vinyl polymer. In general, acrylic ester monomers having at least six carbons in the alcohol portion of the ester or styrene or alkylated styrene, such as tert-butyl styrene, may be included in the polymerized monomers for this purpose. In a preferred embodiment, an ink composition with non-oxygenated solvents includes a branched vinyl polymer polymerized from a monomer mixture including at least about 20%, preferably from about 20% to about 40%, and more preferably from about 20% to about 25% of a monomer that promotes aliphatic solubility such as stearyl methacrylate or t-butyl styrene, with stearyl methacrylate being a preferred such monomer. It is also preferred to include at least about 55% percent styrene, preferably from about 55% to about 80% styrene, and more preferably from about 60% to about 70% styrene. Methyl methacrylate or other monomers may also be used to reduce solvent tolerance in aliphatic solvent, if desired. All percentages are by weight, based upon the total weight of the monomer mixture polymerized. Among preferred monomer compositions for vinyl polymers for lithographic inks are those including a (meth)acrylic ester of an alcohol having 8-20 carbon atoms such as stearyl methacrylate, styrene, divinylbenzene, and (meth)acrylic acid. In a preferred embodiment, a branched vinyl for a lithographic printing ink is made with from about 15, preferably about 20, to about 30, preferably about 25, weight percent of a (meth)acrylic ester of an alcohol having 8-20 carbon atoms, especially stearyl methacrylate; from about 50, preferably about 60, to about 80, preferably about 75, weight percent of a styrenic monomer, especially styrene itself; an amount of divinylbenzene as indicated above; and from about 0.5, preferably about 2.5, to about 5, preferably about 4, weight percent of the monomer unit providing the hydrogen bonding functionality, especially methyacrylic acid.

Preferably, the solvent or solvent mixture will have a boiling point of at least about 100° C. and preferably not more than about 550° C. Offset printing inks may use solvents with boiling point above about 200° C. News inks usually are formulated with from about 20 to about 85 percent by weight of solvents such as mineral oils, vegetable oils, and high boiling petroleum distillates. The amount of solvent also varies according to the type of ink composition (that is, whether the ink is for newsprint, heatset, sheetfed, etc.), the specific solvents used, and other factors known in the art. Typically the solvent content for lithographic inks is up to about 60%, which may include oils as part of the solvent package. Usually, at least about 35% solvent is present in lithographic ink. When used to formulate the preferred ink compositions, these varnishes or vehicles, including the branched vinyl polymers, are typically clear, apparent solutions.

The single fluid ink compositions will usually include one or more pigments. The number and kinds of pigments will depend upon the kind of ink being formulated. News ink compositions typically will include only one or only a few pigments, such as carbon black, while lithographic inks for printing packages and magazines may include a more complicated pigment package and may be formulated in many colors, including colors with special effects such as pearlescence or metallic effect. Lithographic printing inks are typically used in four colors, however—magenta, yellow, black, and cyan, and may be formulated for pearlescence or metallic effect. Any of the customary inorganic and organic pigments may be used in the ink compositions of the present invention. Alternatively, the compositions of the invention may be used as overprint lacquers or varnishes. The overprint lacquers or varnishes are applied over a print image and are intended to be clear or transparent; thus opaque pigments are not included.

Lithographic ink compositions printed in the process of the invention are formulated as single-fluid inks having an oil-based continuous phase that contains the hydrogen bonding vinyl vehicle and a fluid discontinuous phase that contains water and/or a liquid polyol. The vinyl polymer phase is relatively stable toward the emulsified fluid phase. The stability is such that the two phases do not separate in the fountain. During application of the ink, however, the emulsion breaks and the polyol comes to the surface, wetting out the areas of the plate that are not to receive ink. Inks that are stable in the fountain but break quickly to separate on the plate print cleanly without toning and provide consistent transfer characteristics. Proper stability also may depend upon the particular hydrogen bonding functional vinyl polymer and the particular fluid chosen. The degree of functionality and molecular weight may be adjusted to provide the desired stability. In general, it is believed that an increase in hydrogen bonding functionality should be accompanied by a decrease in the amount of such polymer included in the hydrophobic phase.

The emulsified hydrophilic fluid phase contains water, a liquid polyol, or both water and a liquid polyol. Polyethylene glycol oligomers such as diethylene glycol, triethylene glycol, and tetraethylene glycol, as well as ethylene glycol, propylene glycol, and dipropylene glycol, are examples of liquid polyols that are preferred for the polyol phase of the single-fluid ink of the invention. The emulsified phase may, of course, include mixtures of different liquid polyols, and may also include water. In general, vinyl or acrylic polymers with less hydrogen bonding functionality are used with higher molecular weight polyols.

The emulsified fluid phase may include further materials. In one embodiment, the emulsified phase further includes one or more materials selected from solid polyol compounds, solid polyol oligomers, and compounds having one hydroxyl group and up to about 18 carbon atoms, preferably up to about 8 carbon atoms. A weak acid such as citric acid, tartaric acid, or tannic acid, or a weak base such as triethanolamine, may be included in an amount of from about 0.01 weight percent up to about 2 weight percent of the ink composition. Certain hygroscopic inorganic salts such as magnesium nitrate may be included in amounts of from about 0.01 weight percent to about 0.5 weight percent, preferably from about 0.08 to about 1.5 weight percent, based on the weight of the ink composition, to help protect the plate and extend the life of the plate. A wetting agent, such as polyvinylpyrrolidone, may be added to aid in wetting of the plate. From about 0.5 weight percent to about 1.5 weight percent of the polyvinylpyrrolidone is included, based on the weight of the ink composition. From about 0.5 weight percent to about 1.5 weight percent of the polyvinylpyrollidone may be included, based on the weight of the ink composition.

Single-fluid inks may be formulated with from about 5% to about 50%, preferably from about 10% to about 35%, and particularly preferably from about 20% to about 30% of the emulsified fluid phase by weight based on the total weight of the ink composition. Unless another means for cooling is provided, there is preferably a sufficient amount of emulsified fluid in the ink composition to keep the plate at a workably cool temperature. The amount of the emulsified fluid phase necessary to achieve good printing results without toning may depend upon the kind of plate being used and may be determined by straightforward testing.

It will be appreciated by the skilled artisan that other additives known in the art that may be included in the single-fluid ink compositions, so long as such additives do not significantly detract from the benefits of the single-fluid ink. Illustrative examples of these include, without limitation, pour point depressants, surfactants, wetting agents, waxes, emulsifying agents and dispersing agents, defoamers, antioxidants, UV absorbers, dryers (e.g., for formulations containing vegetable oils), flow agents and other rheology modifiers, gloss enhancers, and anti-settling agents. When included, additives are typically included in amounts of at least about 0.001% of the ink composition, and may be included in amount of about 7% by weight or more of the ink composition, depending upon their nature.

The lithographic applications include, without limitation, heatset printing, news ink printing, and sheetfed printiing. Offset printing processes in general are described in many publications. Because the ink is a single fluid lithographic ink, no dampener or separate fluid is used. The emulsified fluid phase is the fluid during printing.

The invention is illustrated by the following example. The example is merely illustrative and does not in any way limit the scope of the invention as described and claimed. All parts are parts by weight unless otherwise noted.

### EXAMPLE

While printing with a single fluid ink having a continuous, hydrophobic colored phase and an emulsified polyol phase, the printing machine was stopped. The plates were cleaned with a plate conditioner prepared by stirring 0.3 parts by weight pentaerythritol into 5 parts by weight heated water, adding 5.45 parts by weight ethylene glycol with heat, then 0.08 parts by weight citric acid, 0.08 parts by weight magnesium nitrate, and finally 19.09 parts by weight ethylene glycol and 70 parts by weight diethylene glycol.

After 1 hour, the press was restarted, and printing with the single fluid ink resumed. The result was a clean print free of toning and unwanted sensitized areas on the printing plate.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1 A printing process, comprising
printing with a lithographic printing press having a printing plate,
stopping the printing press,
applying a plate conditioner to the printing plate, and
after a desired time, starting the printing press and resuming printing,
wherein the plate conditioner comprises an organic liquid having hydroxyl functionality and a solid organic compound that is at least partially soluble in the liquid having hydroxyl functionality.

2. A process according to claim 1, wherein the plate conditioner comprises at least about 5% by weight of a liquid polyol.

3. A process according to claim 1, wherein the plate conditioner comprises from about 10% by weight to about 99% by weight of a liquid polyol.

4. A process according to claim 1, wherein the plate conditioner comprises from about 25% by weight to about 98% by weight of a liquid polyol.

5. A process according to claim 1, wherein the plate conditioner comprises from 50% by weight to about 95% by weight of a liquid polyol.

6. A process according to claim 1, wherein the solid organic compound is selected from the group consisting of solid polyols, gums, and combinations thereof.

7. A process according to claim 1, wherein the solid organic compound has a melting point of at least about 25° C.

8. A process according to claim 1, wherein the organic liquid having hydroxyl functionality is selected from the group consisting of 1,2-propanediol, 1,3-propanediol, diethylene glycol, triethylene glycol, tetraethylene glycol, 1,4-butanediol, 1,3-butanediol, and combinations thereof.

9. A process according to claim 1, wherein the solid organic compound is selected from the group consisting of gum arabic, carboxyl methyl cellulose, carboxyl ethyl cellulose, salts of carboxyl-functional celluloses, poly(vinyl alcohol), poly(vinyl acetate), poly(vinyl pyrrolidone), solid polyalkylene glycols, trimethylol propane, glycerol, pentaerythritol, dipentaerythritol, 2,2,4-trimethylpentanediol, triethylolpropane, hyperbranched polyols based on polyols having three or more hydroxyl groups, cyclohexanedimethanols, and combinations thereof.

10. A process according to claim 1, wherein the plate conditioner comprises from about 0.05% by weight to about 5% by weight of the solid organic compound.

11. A process according to claim 1, wherein the plate conditioner comprises from about 0.1% by weight to about 1% by weight of the solid organic compound.

12. A process according to claim 1, wherein the plate conditioner further comprises water.

13. A process according to claim 12, wherein the solid organic compound is salted with a base.

14. A process according to claim 1, wherein the ink comprises an emulsified fluid phase.

15. A printing process, comprising
printing an ink with a lithographic printing press having a printing plate,
stopping the printing press,
applying a plate conditioner to the printing plate, and
after a desired time, starting the printing press and resuming printing,
wherein the ink comprises
a continuous phase comprising a polymer and
an emulsified phase comprising a member selected from the group consisting of water, liquid polyols, and combinations thereof,
and wherein the plate conditioner comprises
an organic liquid having hydroxyl functionality and
a solid organic compound that is at least partially soluble in the liquid having hydroxyl functionality.

16. A process according to claim 15, wherein the emulsified phase comprises a liquid polyol selected from the group consisting of ethylene glycol, diethylene glycol, triethylene glycol, tetraethylene glycol, propylene glycol, dipropylene glycol, and mixtures thereof.

17. A process according to claim 15, wherein the ink composition includes from about 5% to about 50% of the emulsified phase by weight.

18. A process according to claim 15, wherein the ink composition includes from about 10% to about 35% of the emulsified phase by weight.

19. A process according to claim 15, wherein the ink composition includes from about 20% to about 30% of the emulsified phase by weight.

20. A process according to claim 15, wherein the emulsified phase includes a weak acid or a weak base.

21. A process according to claim 15, wherein the emulsified phase includes a hygroscopic inorganic salt.

22. A process according to claim 15, wherein the emulsified phase is nonaqueous.

23. A process according to claim 15, wherein the polymer has an acid number of at least about 3 mg KOH per gram nonvolatile.

24. A process according to claim 15, wherein the polymer has an acid number of from about 3 to about 30 mg KOH per gram nonvolatile.

25. A process according to claim 15, wherein the polymer has an acid number of from about 8 to about 25 mg KOH per gram nonvolatile.

26. A process according to claim 15, wherein the polymer is branched.

27. A process according to claim 26, wherein the polymer has a number average molecular weight of between about 1000 and about 15,000 and a weight average molecular weight of at least about 100,000.

28. A process according to claim 26, wherein the continuous phase further comprises a member selected from the group consisting of polyester resins, hydrocarbon resins, alkyd resins, phenolic resins, rosins, cellulosic resins, and modifications thereof, and mixtures thereof.

29. A process according to claim 26, wherein the plate conditioner comprises at least about 5% by weight of a liquid polyol.

30. A process according to claim 26, wherein the plate conditioner comprises from about 25% by weight to about 98% by weight of a liquid polyol.

31. A process according to claim 26, wherein the plate conditioner comprises from 50% by weight to about 95% by weight of a liquid polyol.

32. A process according to claim 26, wherein the solid organic compound has a melting point of at least about 25° C.

33. A process according to claim 26, wherein the organic liquid having hydroxyl functionality is selected from the group consisting of 1,2-propanediol, 1,3-propanediol, diethylene glycol, triethylene glycol, tetraethylene glycol, 1,4-butanediol, 1,3-butanediol, and combinations thereof.

34. A process according to claim 26, wherein the solid organic compound is selected from the group consisting of gum arabic, carboxyl methyl cellulose, carboxyl ethyl cellulose, salts of carboxyl-functional celluloses, poly(vinyl alcohol), poly(vinyl acetate), poly(vinyl pyrrolidone), solid polyalkylene glycols, trimethylolpropane, glycerol, pentaerythritol, dipentaerythritol, 2,2,4-trimethylpentanediol, triethylolpropane, hyperbranched polyols based on polyols having three or more hydroxyl groups, cyclohexanedimethanols, and combinations thereof.

35. A process according to claim 26, wherein the plate conditioner comprises from about 0.1% by weight to about 1% by weight of the solid organic compound.

36. A process according to claim 26, wherein the plate conditioner further comprises water.
